(19) United States
(12) Patent Application Publication
(10) Pub. No.: US 2025/0300939 A1
(43) Pub. Date: Sep. 25, 2025

(54) MANAGING NETWORK FLOWS BASED ON APPLICATIONS

(71) Applicant: Arista Networks, Inc., Santa Clara, CA (US)

(72) Inventors: Sean DAO, Gardena, CA (US); Mike T. STOLARCHUK, Ypsilanti, MI (US); Ken CHIANG, Fremont, CA (US); John SCHIMMEL, Royse City, TX (US); Robert LING, San Jose, CA (US); Brett WOLTZ, Simi Valley, CA (US); Ryan IZARD, Seneca, SC (US); Harkirandeep DHILLON, Surrey (CA)

(21) Appl. No.: 18/614,252

(22) Filed: Mar. 22, 2024

(51) Int. Cl. H04L 47/2483; H04L 47/20; H04L 47/2475

(52) U.S. Cl. CPC H04L 47/2483; H04L 47/20; H04L 47/2475

(57) ABSTRACT

Some embodiments provide a method that receives a policy to filter traffic from a network. The policy specifies the traffic to be filtered in terms of an application name of an application that generates the traffic to be filtered. Data packets from the network are received. Packet information in the received data packets generated by the application based on the application name are identified. A mapping between the application name and the identified packet information is forwarded to a first set of monitoring tools. The received data packets are processed by using the identified packet information to identify data packets generated by the application in the network from among the received data packets and forwarding the identified data packets to a second set of monitoring tools based on the policy.

### BACKGROUND

Network flows in computer networks are conventionally identified by their 5-tuples, namely their source Internet Protocol (IP) address, source port, destination IP address, destination port, and protocol. Network operators who are troubleshooting issues in their network need to be able to identify the applications that source the traffic. Viewing flows as 5-tuples is challenging, disruptive, and otherwise inconvenient because the network operator must set up a mapping between the 5-tuples and their corresponding applications. The challenge is exacerbated with cloud applications and in content distributed networks (CDNs) because the same application can be associated with multiple 5-tuples.

The following detailed description and accompanying drawings provide a better understanding of the nature and advantages of various embodiments of the present disclosure.

### BRIEF DESCRIPTION OF THE DRAWINGS

FIG. 1 illustrates a system for managing network flows based on applications according to some embodiments.

FIG. 2 illustrates the network packet monitoring system illustrated in FIG. 1 configured for application identification according to some embodiments.

FIG. 3 illustrates the network packet monitoring system illustrated in FIG. 1 configured for application filtering according to some embodiments.

FIG. 4 illustrates a process for managing network flows based on applications according to some embodiments.

FIG. 5 illustrates an architecture of the analytics node illustrated in FIG. 1 according to some embodiments.

FIG. 6 illustrates a process for canonicalizing application names according to some embodiments.

FIG. 7 illustrates a process for processing a query for network traffic based on an application according to some embodiments.

FIG. 8 illustrates an example computer system according to some embodiments.

FIG. 9 illustrates an example network device according to some embodiments.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for managing network flows based on applications. In some embodiments, a system includes a network, a network packet monitoring system configured to monitor the network, and one or more networking tools. The network packet monitoring system can monitor the network traffic at one or more points in the network by receiving copies of all the network traffic at those points in the network. The network and the network packet monitoring system are separate components of the system. The network packet monitoring system can be referred to as an out-of-band monitoring system. The network packet monitoring system may include an application identification service that is configured to identify distinct network flows in the network traffic based on the copies of the network traffic. In some embodiments, a distinct network flow is identified by a 5-tuple of packet header values that include a source IP address, a source port, a destination IP address, a destination port, and a protocol. For each distinct network flow, the network packet monitoring system determines an application that is associated with the network flow (e.g., an application that generated and/or used packets in the network flow). The network packet monitoring system may send the network flow and the associated application data to a networking tool for further processing. In addition, the network packet monitoring system can filter the copies of the network traffic based on applications associated with the network traffic. For example, the network packet monitoring system may drop all packets associated with a set of defined applications. As another example, the network packet monitoring system can allow only packets associated with a set of defined applications. Once filtered, the network packet monitoring system may forward the filtered packets to a network tool for further processing.

The techniques described in the present application provide a number of benefits and advantages over conventional methods for managing network flows based on applications. For instance, providing an out of band monitoring system that automatically maps applications to network flows (e.g., 5-tuples) allows network flows belonging to a particular application to be identified faster than conventional methods. For example, conventional methods can utilize manual mapping of applications to network flows.

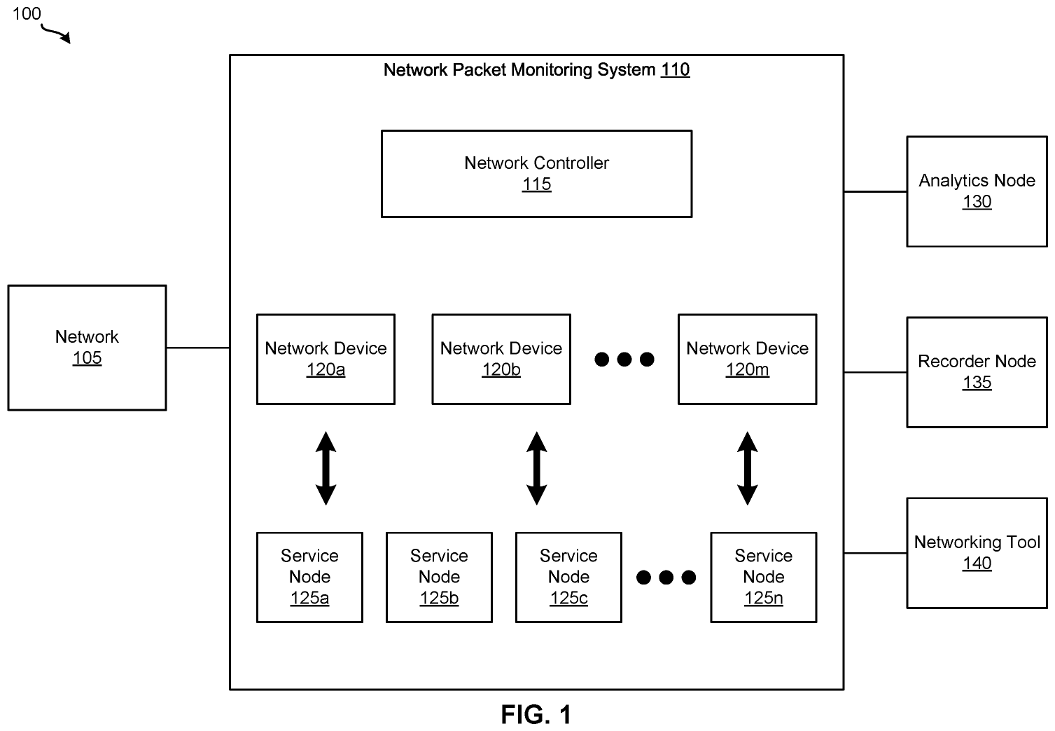

FIG. 1 illustrates a system 100 for managing network flows based on applications according to some embodiments. As shown, system 100 includes network 105, network packet monitoring system 110, analytics node 130, recorder node 135, and network tool 140. While FIG. 1 depicts one analytics node 130, one recorder node 135, and one network tool 140, one of ordinary skill in the art will understand that any number of similarly configured nodes and/or tools may be included in system 100. Similarly, system 100 can include any number of additional networks (e.g., similar to network 105) that are monitored by network packet monitoring system 110. Network 105 may be a computer network that includes a set of networking devices (e.g., switches, routers, bridges, gateways, etc.) configured to process network traffic (e.g., packets) through the network to their intended destinations. In some embodiments, network 105 may be a local area network (LAN), a wide area network (WAN), a network of networks (e.g., the Internet), etc. or any combination thereof. In some cases, network 105 may be referred to as a production network. In some embodiments, a production network includes a filter port and a delivery port where traffic flows are configured to flow bidirectionally between the filter port and the delivery port. On the other hand, in some such embodiments, a monitoring network (e.g., the network implemented by network devices 120a-m in network packet monitoring system 110) includes a filter port and a delivery port where traffic flows are configured to flow unidirectionally from the filter port to the delivery port.

Analytics node 130 is responsible for analyzing data received from network packet monitoring system 110. For example, analytics node 130 can receive application identification metadata (e.g., IP flow information export (IPFIX) messages) from network packet monitoring system 110 (e.g., application identification metadata associated with network flows in network 105). In some cases where application identification metadata is generated by different sources (e.g., different application identification services), analytics node 130 may canonicalize application identifiers (IDs) and application names in the application identification metadata that analytics node 130 receives. In some embodiments, analytics node 130, in conjunction with recorder node 135, provides a search feature where users can search for network flows based on names of applications.

Recorder node 135 is configured to provide packet recording, querying, and replay functions. For example, recorder node 135 can receive packets from network packet monitoring system 110 (e.g., copies of packets transmitted in network 105), which recorder node 135 stores. Recorder node 135 may receive queries (e.g., from analytics node 130) for packets (e.g., packets having values that match a specified 5-tuple and/or a time value that falls within a specified time range).

Network tool 140 can be any number of different tools used for networks. Examples of network tools include a network performance monitoring tool, an application performance monitoring tool, a network security tool, a voice over IP (VOIP) monitoring tool, a network traffic recorder, etc. In some embodiments, network tool 140 may receive data from network packet monitoring system 110 (e.g., application identification metadata, copies of packets transmitted in network 105, etc.).

Network packet monitoring system 110 serves to monitor network 105. Although FIG. 1 shows only one network monitored by network packet monitoring system 110, one of ordinary skill in the art will appreciate that system 100 can include any number of networks that are monitored by network packet monitoring system 110 using the same techniques described herein to monitor network 105. As illustrated in FIG. 1, network packet monitoring system 110 includes network controller 115, network devices 120a-m, and service nodes 125a-n. Network controller 115 is responsible for configuring network packet monitoring system 110 to operate according to specified configurations. For instance, network controller 115 can receive a configuration (e.g., from a user) that specifies a set of packet sources, a set of targets, and a set of services. A configuration may also be referred to as a policy. The set of packet sources indicates a set of interfaces in network 105 (e.g., a switch port analyzer (SPAN) interface of a network switch, an interface of a network tap device, etc.) from which packets are copied and transmitted to network packet monitoring system 110. The set of targets indicates the destination (e.g., analytics node 130, recorder node 135, and/or networking tool 140) where network packet monitoring system 110 sends data after network packet monitoring system 110 generates and/or processes the data. The set of services specifies services that network packet monitoring system 110 is to perform on the copies of packets. Configuring network packet monitoring system 110 to operate according to a given configuration can include provisioning one or more services nodes 125a-n with the specified set of services, configuring network devices 120a-m to forward the copies of packets received from network 105 to the one or more service nodes 125a-n, and configuring network devices 120a-m to forward data from the one or more service nodes 125a-n to the set of targets.

Each of the network devices 120a-m is configured to forward network traffic (e.g., copies of packets) received from network 105 to their intended destinations. For example, network devices 120a-m may be configured to forward the network traffic to a service node 125 and forward network traffic received from the service node 125 to analytics node 130, recorder node 135, or networking tool 140. As mentioned above, network controller 115 can configure (e.g., based on a received configuration) how network devices 120a-m forwards network traffic through network packet monitoring system 110.

Each of the service nodes 125a-n is responsible for providing one or more services for network packet monitoring system 110. Examples of services include an application identification service, an application filtering service, a deduplication service, a packet slicing service, a header stripping service, a packet masking service, a packet matching service, a packet replication service, etc. In some cases, a service node 125 can be provisioned (e.g., by network controller 115) with one or more services. In some instances, several service nodes 125 may be provisioned (e.g., by network controller 115) with the same service.

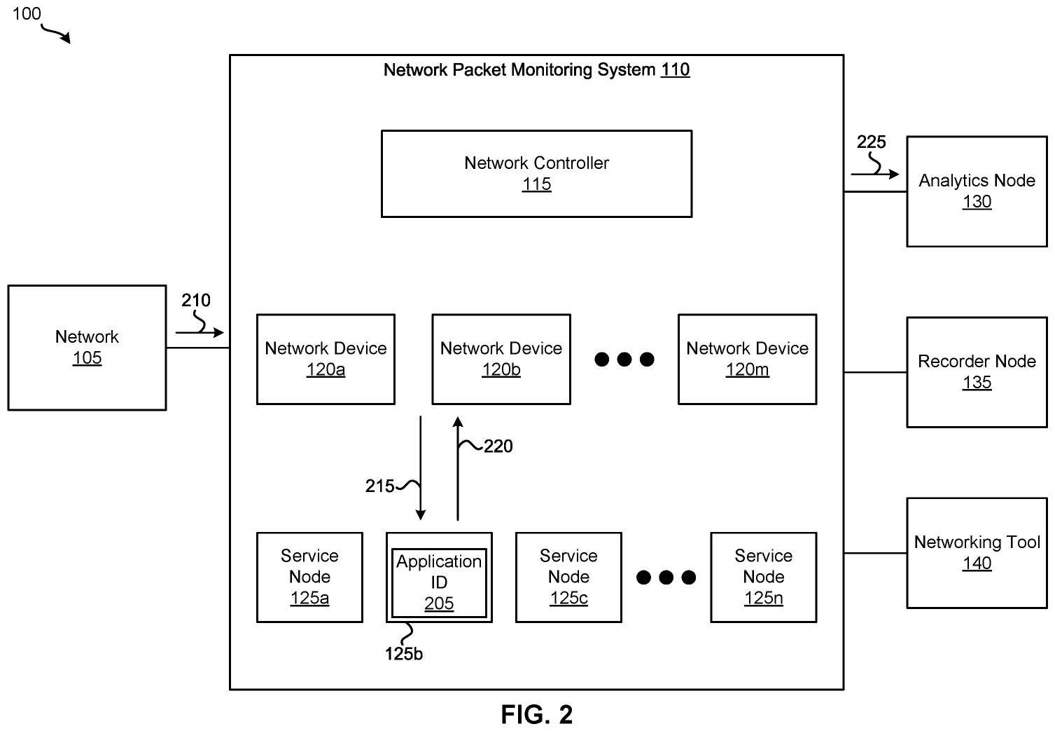

An example operation will now be described by reference to FIG. 2. Specifically, this example operation will demonstrate how network packet monitoring system 110 can be configured to identify applications associated with network flows. FIG. 2 illustrates network packet monitoring system 110 configured for application identification according to some embodiments. For this example, network controller 115 received a configuration that specifies a set of interfaces (e.g., a SPAN interface of a network switch, an interface of a network tap device, etc.) in network 105 as the set of packet sources, analytics node 130 as the set of targets, and application identification as the set of services. In response to receiving the configuration, network packet monitoring system 110 provisions service node 125b with an application identification service. As shown in FIG. 2, service node 125b is provisioned with application identification service 205. Here, application identification service 205 is configured to identify applications associated with network flows based on received packets. In addition, network packet monitoring system 110 configures, in response to receiving the configuration, network devices 120a-m to forward traffic received from network 105 to service node 125b and forward traffic received from service node 125b to analytics node 130.

The operation begins by network devices 120a-m receiving, at 210, copies of network traffic from network 105. In particular, each interface in network 105 that is specified in the configuration is configured to generate a copy of each packet that it processes/receives and transmit the copy of the packet to network packet monitoring system 110. Upon receiving the copies of network traffic, network devices 120a-m forward, at 215, them to service node 125b for processing.

When service node 125b receives a packet from network devices 120a-m, application identification service 205 determines whether the packet belongs to an existing network flow tracked by application identification service 205. In some embodiments, application identification service 205 makes the determination by performing a set of deep packet inspection (DPI) operations that can include inspecting values in one or more headers of the packet and inspecting the payload of the packet. If application identification service 205 determines that the packet belongs to a new network flow (i.e., the packet does not belong to an existing network flow), application identification service 205 determines an application associated with the new network flow. In some embodiments, application identification service 205 may determine an application associated with the new network flow by using an application signature database that stores mappings between application signatures and their corresponding applications. In some such embodiments, application identification services 205 can determine an application associated with the new network flow (e.g., an application that generated data transported through network 105 via the network flow) by identifying an application signature in the packet, searching the application signature database to find an application signature that matches the application signature in the packet, and determining that the corresponding application of the matching application signature in the application signature database is the application associated with the new network flow. In some instances, application identification service 205 generates a message (e.g., an IPFIX message) that includes the network flow information of the new network flow (e.g., the source IP address specified in the packet, the source port specified in the packet, the destination IP address specified in the packet, the destination port specified in the packet, and the protocol specified in the packet) and the determined associated application. Next, application identification service 205 sends, at 220, the message to network devices 120a-m. Once network devices 120a-m receive the message, network devices 120a-m forward, at 225, the message to analytics node 130 for processing.

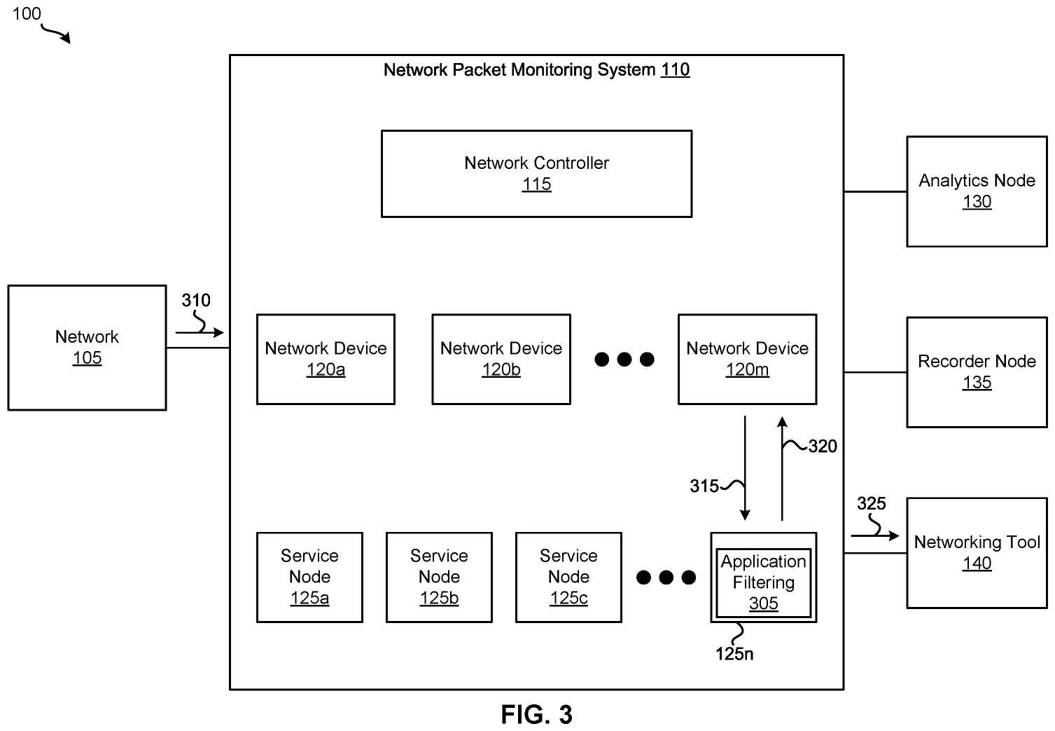

Another example operation will now be described by reference to FIG. 3. For this example, the operation will show how network packet monitoring system 110 can be configured to filter packets of network flows based on applications. FIG. 3 illustrates network packet monitoring system 110 configured for application filtering according to some embodiments. In this example, network controller 115 received a configuration that specifies a set of interfaces (e.g., a SPAN interface of a network switch, an interface of a network tap device, etc.) in network 105 as the set of packet sources, analytics node 130 as the set of targets, and application filtering as the set of services. Additionally, the configuration specifics a set of applications (e.g., a set of application names of the set of applications) and that packets of network flows associated with the set of applications are allowed. Upon receiving the configuration, network packet monitoring system 110 provisions service node 125n with an application filtering service. As depicted in FIG. 3, service node 125n is provisioned with application filtering service 305. For this example, application filtering service 305 is configured to filter packets of network flows based on applications. Also, network packet monitoring system 110 configures, upon receiving the configuration, network devices 120a-m to forward traffic received from network 105 to service node 125n and forward traffic received from service node 125n to networking tool 140.

The operation starts by network devices 120a-m receiving, at 310, copies of network traffic from network 105. Here, each interface in network 105 that is specified in the configuration is configured to generate a copy of each packet that it processes/receives and transmit the copy of the packet to network packet monitoring system 110. Once network devices 120a-m receives the copies of network traffic, network devices 120a-m forward, at 315, them to service node 125n for processing.

When service node 125n receives a packet from network devices 120a-m, application filtering service 305 determines an application associated with the packet (e.g., an application that generated data transported through network 105 via the packet). In some embodiments, application filtering service 305 determines an application associated with the packet by performing a set of deep packet inspection (DPI) operations (e.g., inspecting values in one or more headers of the packet, inspecting the payload of the packet, etc.) and using an application signature database that stores mappings between application signatures and their corresponding applications. In some such embodiments, application filtering service 305 can use the application signature database to determine an application associated with the packet by identifying an application signature in the packet, searching the application signature database to find an application signature that matches the application signature in the packet, and determining that the corresponding application of the matching application signature in the application signature database is the application associated with the packet.

After determining an application associated with the packet, application filtering service 305 determines whether to allow the packet based on the associated application. In particular, if the application associated with the packet is included in the set of applications specified in the configuration, application filtering service 305 allows the packet. Otherwise, application filtering service 305 drops the packet. If the packet is allowed, application filtering service 305 sends, at 320, the packet to network devices 120a-m. Upon receiving the packet, network devices 120a-m forward, at 325, the packet to networking tool 140 for processing.

The examples described above illustrate how network packet monitoring system 110 can be configured to perform different functions based on applications (i.e., identifying network flows based on applications and filtering packets based on applications). In some embodiments, these different functions may be used in conjunction. For example, a configuration in some such embodiments may specify both the application identification service and the application filtering service. Network controller 110 would configure network packet monitoring system 110 to perform application identification on copies of packets received from network 105 and then perform application filtering on the copies of packets.

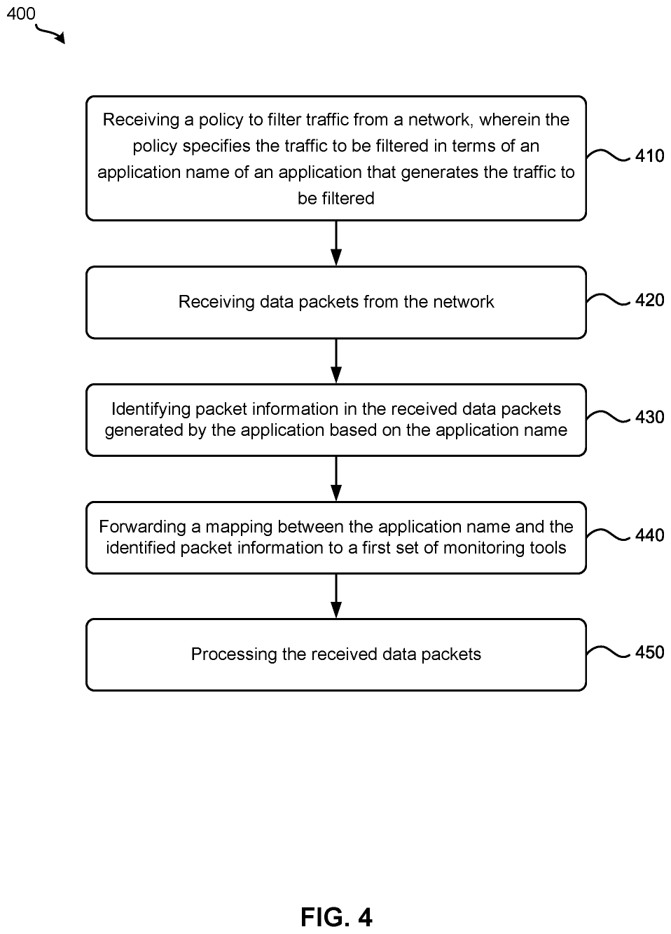

FIG. 4 illustrates a process 400 for managing network flows based on applications according to some embodiments. In some embodiments, network packet monitoring system 110 performs process 400. Process 400 begins by receiving, at 410, a policy to filter traffic from a network. The policy specifies the traffic to be filtered in terms of an application name of an application that generates the traffic to be filtered. For instance, network controller 115 may receive a configuration that specifies a set of interfaces (e.g., a SPAN interface of a network switch, an interface of a network tap device, etc.) in network 105 as the set of packet sources, analytics node 130 as the set of targets, application identification and application filtering as the set of services, a set of application names of a set of applications, and that packets of network flows associated with the set of applications are allowed.

Next, process 400 receives, at 420, data packets from the network. Referring to FIG. 2 as an example, network packet monitoring system 110 can receive copies of network traffic from network 105.

Process 400 then identifies, at 430, packet information in data packets generated by the application based on the application name. Referring to FIG. 2 as an example, network devices 120a-m can receive copies of network traffic from network 105. Each interface in network 105 that is specified in the configuration is configured to generate a copy of each packet that it processes/receives and transmit the copy of the packet to network packet monitoring system 110. Upon receiving the copies of network traffic, network devices 120a-m forward them to service node 125b for processing. For each received packet, application identification service 205, which is provisioned on service node 125b, determines whether the packet belongs to an existing network flow tracked by application identification service 205. If application identification service 205 determines that the packet belongs to a new network flow (i.e., the packet does not belong to an existing network flow), application identification service 205 determines an application associated with the new network flow (e.g., the application that generated the packet in network 105).

At 440, process 400 forwards a mapping between the application name and the identified packet information to a first set of monitoring tools, wherein when the first set of monitoring tools receive queries from a user that specifies traffic using the application name, the first set of monitoring tools use the mapping to access data packets based on the packet information associated with the application name. Referring to FIG. 2 as an example, for every packet that is determined to belong to a new network flow, application identification service 205 can determine an application associated with the new network flow and then generate a message (e.g., an IPFIX message) that includes the network flow information of the new network flow (e.g., the source IP address specified in the packet, the source port specified in the packet, the destination IP address specified in the packet, the destination port specified in the packet, and the protocol specified in the packet) and the determined associated application. Application identification service 205 sends these messages to network devices 120a-m, which forward the messages to analytics node 130. Analytics node 130 can provide a search feature where users can search for network flows based on names of applications. For the search feature, analytics node 130 use the messages to process the searches.

Finally, process 400 processes, at 450, the received data packets. Process 400 processes the received data packet by using the identified packet information to identify data packets generated by the application in the network from among the received data packets and forwarding the identified data packets to one or more monitoring tools based on the policy. Referring to FIG. 3 as an example, for each received packet, application filtering service 305, which is provisioned on service node 125n, determines an application associated with the packet and then determines whether to allow the packet based on the associated application and the application specified in the policy. Application filtering service 305 sends the allowed packets to network devices 120a-m, which forward the packets to networking tool 140.

In some instances, network packet monitoring system 110 may employ multiple different application identification services that use different application identification metadata to describe the same applications (e.g., different application identifiers and/or application names). In some of those instances, analytics node 130 receives application identification metadata from these different application identification services. In order to reconcile different application identification metadata describing the same application, analytics node 130 employs a feature for canonicalizing application identification metadata, in some embodiments.

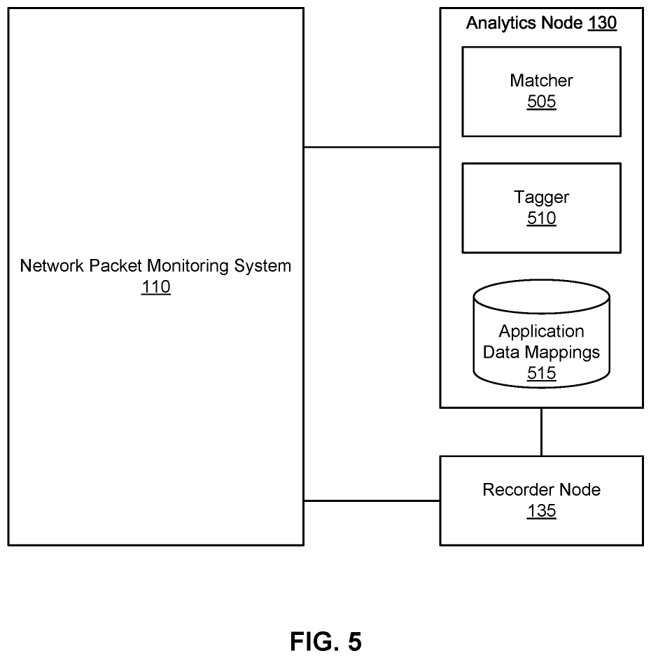

FIG. 5 illustrates an architecture of analytics node 130 for implementing a feature for canonicalizing application identification metadata according to some embodiments. As shown, analytics node 130 includes matcher 505, tagger 510, and application data mappings storage 515. Application data mappings storage 515 is configured to store mappings between local application identification metadata and global application identification metadata.

Matcher 505 is responsible for managing application identification metadata. For instance, matcher 505 may receive application identification metadata from different application identification services in network packet monitoring system 110. The received application identification metadata can be referred to as local application identification metadata. In some cases, matcher 505 receives different application identification metadata from different application identification services that describe the same application. As an example, matcher 505 can receive a first set of local application identification metadata from a first application identification service in network packet monitoring system 110 and receive a second set of local application identification metadata from a second application identification service in network packet monitoring system 110. For this example, the first set of local application identification metadata may include “application ID1” and “application name 1” that the first application identification service uses for an application. “Application ID1” is a unique identifier for identifying the application and “application name 1” is an application name of the application. In this example, the second set of local application identification metadata may include “application ID2” and “application name 2” that the second application identification service uses for the same application. “Application ID2” is a unique identifier for identifying the same application and “application name 2” is an application name of the same application. Thus, for this example, matcher 505 receives two different unique identifiers that identify the same application and two different application names for the same application.

In some embodiments, matcher 505 can determine that different application identification metadata received from different application identification services in network packet monitoring system 110 are used to describe the same application. In some such embodiments, matcher 505 makes this determination by using a technique that determines different application identification metadata describe the same application based on the application names in the different application identification metadata. Examples of such a technique include fuzzy matching (e.g., Levenshtein fuzzy matching), a semantic similarity large language model (LLM), etc. Continuing with the example in the previous paragraph, matcher 505 can determine that the first set of local application identification metadata and the second set of local application identification metadata are both used to describe the same application by using the technique to determine that “application name 1” and “application name 2” refer to the same application. When matcher 505 determines that different application identification metadata are used to describe the same application, matcher 505 generates a set of global application identification metadata. The set of global application identification metadata can include a global unique identifier for identifying the application and a global application name of the application. Continuing with the example, matcher 505 may generate a set of global application identification metadata for the first set of local application identification metadata and the second set of local application identification metadata that includes “application ID3” as the global unique identifier for the application and “application name 3” as the global application name of the application.

After matcher 505 generates a set of global application identification metadata, matcher 505 generates a configuration (e.g., a configuration file) that includes a set of mappings between the different local application identification metadata describing the same application and global application identification metadata. Continuing with the example in the previous paragraph, matcher 505 may generate a configuration that includes a first mapping that maps the first set of local application identification metadata (i.e., “application ID1” and “application name 1”) to the generated set of global application identification metadata (i.e., “application ID3” and “application name 3”) and a second mapping that maps the second set of local application identification metadata (i.e., “application ID2” and “application name 2”) to the generated set of global application identification metadata (i.e., “application ID3” and “application name 3”). Matcher 505 sends the configuration to tagger 510 to use for processing application identification metadata.

Tagger 510 is configured to associate local application identification metadata with global application identification metadata. For example, tagger 510 can receive a set of local application identification metadata from network packet monitoring system 110. In response to receiving the set of local application identification metadata, tagger 510 determines a set of global application identification metadata that is associated with the set of local application identification metadata based on the configuration(s) that tagger 510 receives from matcher 505. In some embodiments, tagger 510 determines that a set of global application identification metadata is associated with a set of local application identification metadata by identifying a mapping in the configuration(s) that includes a particular set of local application identification metadata that matches the set of local application identification metadata. Next, tagger 510 determines the set of global application identification metadata specified in the identified mapping as the set of global application identification metadata that is associated with the set of local application identification metadata. Then, tagger 510 stores a mapping between the set of local application identification metadata and the associated set of global application identification metadata.

In some embodiments, analytics node 130 may receive (e.g., from users) queries for network traffic based on global application names. When analytics node 130 receives a query from a user for network traffic in terms of a set of global application names, analytics node 130 identifies a set of network flows that are associated with the set of global application names. In some embodiments, analytics node 130 identifies the set of network flows by accessing application data mappings storage 515 and identifying any mappings that specify an application name in the set of global application identification metadata that matches a global application name in the set of global application names. For each identified mapping in application data mappings storage 515, analytics node 130 identifies a network flow (e.g., a 5-tuple of values that include a source IP address, a source port, a destination IP address, a destination port, and a protocol) based on the network flow information included in the local application identification metadata specified in the mapping and includes the network flow in the set of network flows.

Analytics node 130 then sends the identified set of network flows to recorder node 135 and a request for packets that match the set of network flows. Once recorder node 135 receives the set of network flows and the request, recorder node 135 searches its storage of packets and identifies packets that match a network flow in the set of network flows (e.g., packets that have the same 5-tuple of values as a network flow in the set of network flows). In some instances, the request recorder node 135 receives from analytics node 130 specifies a time range for each network flow. In some such instances, the packets that recorder node 135 identifies are packets that match a network flow in the set of network flows and that have a time value that falls within a specified time range of the network flow. Record node 135 sends the identified packets to analytics node 130. Analytics node 130 forwards the packets to the user.

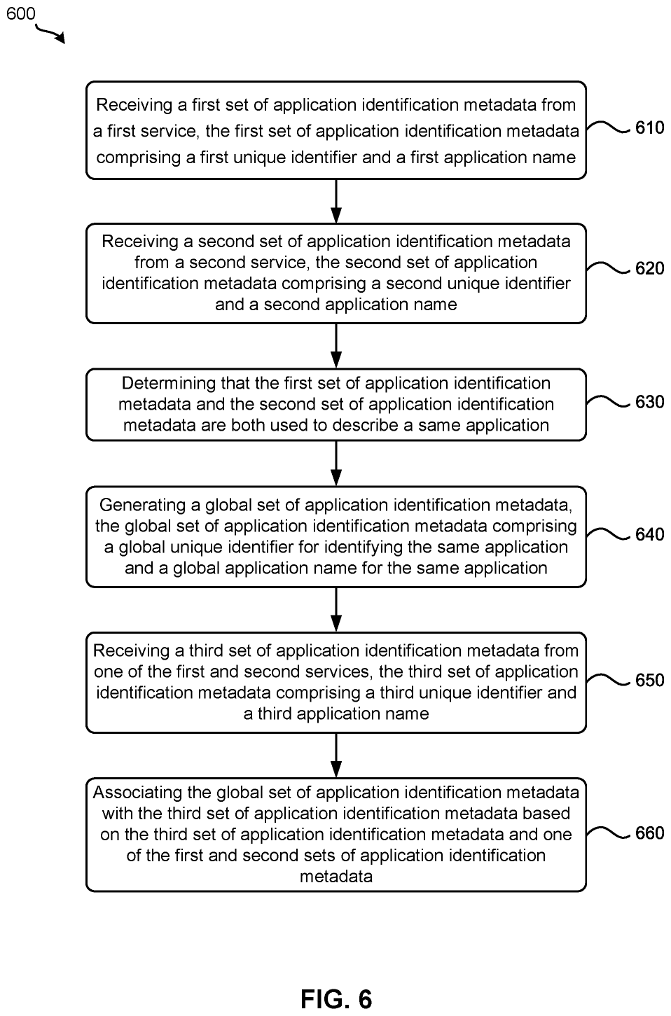

FIG. 6 illustrates a process 600 for canonicalizing application names according to some embodiments. In some embodiments, analytics node 130 performs process 600. Process 600 starts by receiving, at 610, a first set of application identification metadata from a first service. The first set of application identification metadata comprising a first unique identifier and a first application name. Referring to FIG. 5 as an example, matcher 505 may receive a first set of local application identification metadata from a first application identification service in network packet monitoring system 110. The first set of local application identification metadata includes “application ID1” and “application name 1” that the first application identification service uses for an application. “Application ID1” is a unique identifier for identifying the application and “application name 1” is an application name of the application.

Next, process 600 receives, at 620, a second set of application identification metadata from a second service. The second set of application identification metadata comprises a second unique identifier and a second application name. Referring to FIG. 5 as an example, matcher 505 can receive a second set of local application identification metadata from a second application identification service in network packet monitoring system 110. The second set of local application identification metadata includes “application ID2” and “application name 2” that the second application identification service uses for the same application. “Application ID2” is a unique identifier for identifying the same application and “application name 2” is an application name of the same application.

Process 600 then determines, at 630, that the first set of application identification metadata and the second set of application identification metadata are both used to describe a same application. Referring to FIG. 5 as an example, matcher 505 can make this determination by using a technique that determines different application identification metadata describe the same application based on the application names in the different application identification metadata (e.g., Levenshtein fuzzy matching, a semantic similarity LLM, etc.).

At 640, process 600 generates a global set of application identification metadata. The global set of application identification metadata comprising a global unique identifier for identifying the same application and a global application name for the same application. Referring to FIG. 5 as an example, after determining that different application identification metadata are used to describe the same application, matcher 505 generates a set of global application identification metadata. The set of global application identification metadata can include a global unique identifier for identifying the application and a global application name of the application. For instance, continuing with the example used above in operations 610 and 620, matcher 505 can generate a set of global application identification metadata for the first set of local application identification metadata and the second set of local application identification metadata that includes “application ID3” as the global unique identifier for the application and “application name 3” as the global application name of the application. Next, matcher 505 generates a configuration (e.g., a configuration file) that includes a set of mappings between the different local application identification metadata describing the same application and global application identification metadata and then sends the configuration to tagger 510 to use for processing application identification metadata.

Next, process 600 receives, at 650, a third set of application identification metadata from one of the first and second services. The third set of application identification metadata comprises a third unique identifier and a third application name. Referring to FIG. 5 as an example, tagger 510 may receive a set of local application identification metadata from network packet monitoring system 110. In response, tagger 510 determines a set of global application identification metadata that is associated with the set of local application identification metadata based on the configuration that tagger 510 receives from matcher 505.

Finally, process 600 associates, at 660, the global set of application identification metadata with the third set of application identification metadata based on the third set of application identification metadata and one of the first and second sets of application identification metadata. Referring to FIG. 5 as an example, tagger 510 can determines that a set of global application identification metadata is associated with a set of local application identification metadata by identifying a mapping in the configuration that includes a particular set of local application identification metadata that matches the set of local application identification metadata. Tagger 510 then determines the set of global application identification metadata specified in the identified mapping as the set of global application identification metadata that is associated with the set of local application identification metadata. Next, tagger 510 stores a mapping between the set of local application identification metadata and the associated set of global application identification metadata.

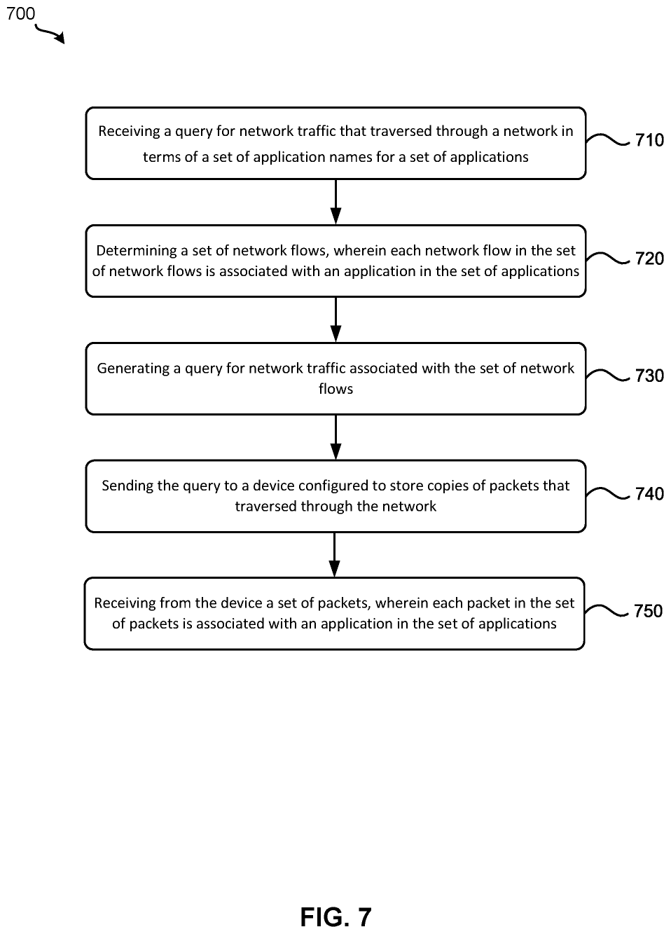

FIG. 7 illustrates a process 700 for processing a query for network traffic based on an application according to some embodiments. In some embodiments, analytics node 130 performs process 700. Process 700 begins by receiving, at 710, a query for network traffic that traversed through a network in terms of a set of application names for a set of applications. Referring to FIG. 5 as an example, analytics node 130 can receive a query from a user for network traffic in terms of a set of global application names.

Next, process 700 determines, at 720, a set of network flows. Each network flow in the set of network flows is associated with an application in the set of applications. Referring to FIG. 5 as an example, in response to receiving the query, analytics node 130 can identify a set of network flows that are associated with the set of global application names by accessing application data mappings storage 515 and identifying any mappings that specify an application name in the set of global application identification metadata that matches a global application name in the set of global application names. For each identified mapping in application data mappings storage 515, analytics node 130 identifies a network flow (e.g., a 5-tuple of values that include a source IP address, a source port, a destination IP address, a destination port, and a protocol) based on the network flow information included in the local application identification metadata specified in the mapping and includes the network flow in the set of network flows.

Process 700 then generates, at 730, a query for network traffic associated with the set of network flows. Referring to FIG. 5 as an example, analytics node 130 generates a request for packets that match the set of network flows. At 740, process 700 sends the query to a device configured to store copies of packets that traversed through the network. Referring to FIG. 5 as an example, analytics node 130 sends recorder node 135 the generated request along with the identified set of network flows.

Finally, process 700 receives, at 750, from the device a set of packets, wherein each packet in the set of packets is associated with an application in the set of applications. Referring to FIG. 5 as an example, when recorder node 135 receives the set of network flows and the request, recorder node 135 searches its storage of packets and identifies packets that match a network flow in the set of network flows (e.g., packets that have the same 5-tuple of values as a network flow in the set of network flows). Record node 135 sends the identified packets to analytics node 130. Upon receiving the identified packets, analytics node 130 forwards them to the user.

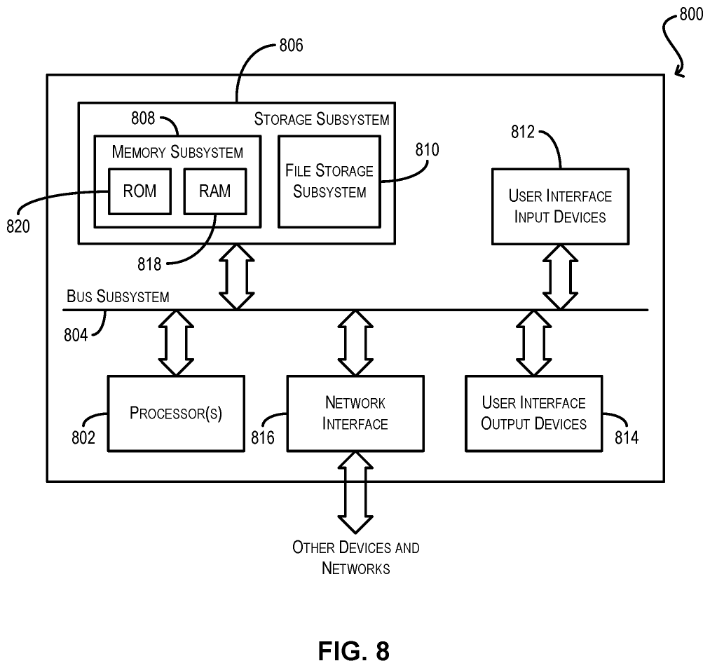

FIG. 8 depicts an example computer system 800 according to some embodiments. Computer system 800 can be used to implement any of the computing devices, systems, servers, network elements, etc., described in the foregoing disclosure. For instance, computing system 800 may be used to implement network controller 115, network devices 120a-m, service nodes 125a-n, analytics node 130, recorder node 135, and networking tool 140 depicted in FIGS. 1-3 and 5. As shown in FIG. 8, computer system 800 includes one or more processors 802 that communicate with a number of peripheral devices via a bus subsystem 804. These peripheral devices include a storage subsystem 806 (comprising a memory subsystem 808 and a file storage subsystem 810), user interface input devices 812, user interface output devices 814, and a network interface subsystem 816.

Bus subsystem 804 can provide a mechanism for letting the various components and subsystems of computer system 800 communicate with each other as intended. Although bus subsystem 804 is shown schematically as a single bus, alternative embodiments of the bus subsystem can utilize multiple buses.

Network interface subsystem 816 can serve as an interface for communicating data between computer system 800 and other computer systems or networks. Embodiments of network interface subsystem 816 can include, e.g., an Ethernet card, a Wi-Fi and/or cellular adapter, a modem (telephone, satellite, cable, ISDN, etc.), digital subscriber line (DSL) units, and/or the like.

User interface input devices 812 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 800.

User interface output devices 814 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 800.

Storage subsystem 806 includes a memory subsystem 808 and a file/disk storage subsystem 810. Subsystems 808 and 810 represent non-transitory computer-readable storage media that can store program code and/or data that provide the functionality of embodiments of the present disclosure.

Memory subsystem 808 includes a number of memories including a main random access memory (RAM) 818 for storage of instructions and data during program execution and a read-only memory (ROM) 820 in which fixed instructions are stored. File storage subsystem 810 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 800 is illustrative and many other configurations having more or fewer components than system 800 are possible.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

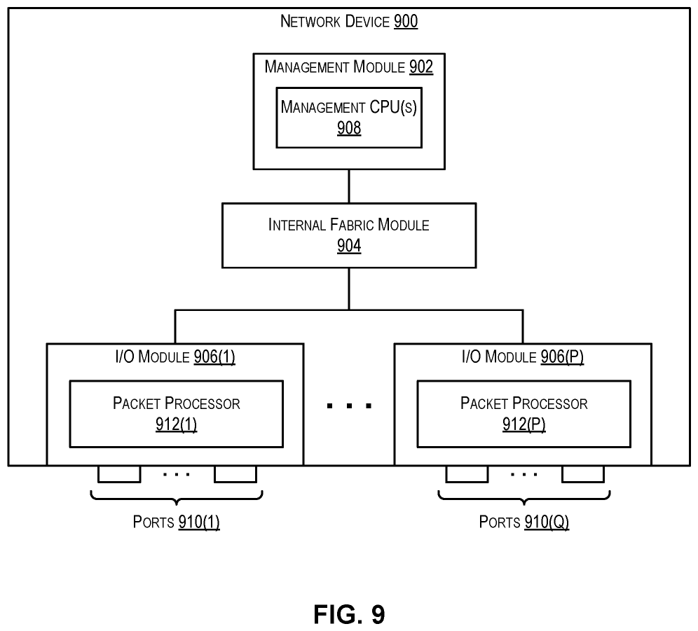

FIG. 9 illustrates the architecture of an example network device (e.g., a network switch or router) 900 that may implement the techniques of the present disclosure according to certain embodiments. For example, network device 900 may be used to implement network devices 120a-m shown in FIGS. 1-3.

Network device 900 includes a management module 902, an internal fabric module 904, and a number of I/O modules 906(1)-(P). Management module 902 includes one or more management CPUs 908 for managing/controlling the operation of the device. Each management CPU 908 can be a general-purpose processor, such as an Intel/AMD x86 or ARM-based processor, that operates under the control of program code maintained in an associated volatile memory and/or stored in a non-transitory computer readable storage medium (not shown). In one set of embodiments, this program code can include code for implementing some or all of the techniques described in the foregoing sections.

Internal fabric module 904 and I/O modules 906(1)-(P) collectively represent the data, or forwarding, plane of network device 900. Internal fabric module 904 is configured to interconnect the various other modules of network device 900. Each I/O module 906 includes one or more input/output ports 910(1)-(Q) that are used by network device 900 to send and receive network packets. Each I/O module 906 can also include a packet processor 912, which is a hardware processing component that can make wire speed decisions on how to handle incoming or outgoing network packets.

It should be appreciated that network device 900 is illustrative and other configurations having more or fewer components than network device 900 are possible.

The following are some example embodiments of the present disclosure. In some embodiments, the techniques described herein relate to a method for managing network flows and executable by a network packet monitoring system, the method comprising receiving a policy to filter traffic from a network, wherein the policy specifies the traffic to be filtered in terms of an application name of an application that generates the traffic to be filtered; receiving data packets from the network; identifying packet information in the received data packets generated by the application based on the application name; forwarding a mapping between the application name and the identified packet information to a first set of monitoring tools, wherein when the first set of monitoring tools receive queries from a user that specifies traffic using the application name, the first set of monitoring tools use the mapping to access data packets based on the packet information associated with the application name; and processing the received data packets, including using the identified packet information to identify data packets generated by the application in the network from among the received data packets and forwarding the identified data packets to a second set of monitoring tools based on the policy.

In some embodiments, the techniques described herein relate to a method, wherein the identified data packets are forwarded to the second set of monitoring tools when the policy includes an action to allow data packets associated with the application identified by the application name set forth in the policy.

In some embodiments, the techniques described herein relate to a method, wherein the identified data packets are dropped and not forwarded to the second set of monitoring tools when the policy includes an action to drop data packets associated with the application identified by the application name set forth in the policy.

In some embodiments, the techniques described herein relate to a method further comprising using an application signature database to identify the packet information in the data packets generated by the application based on the application name.

In some embodiments, the techniques described herein relate to a method, wherein the policy is user-provided input that specifies the traffic to be filtered in terms of the application.

In some embodiments, the techniques described herein relate to a method further comprising matching the identified packet information with information in the received data packets to identify data packets generated by the application in the network from among the received data packets.

In some embodiments, the techniques described herein relate to a method, wherein a monitoring tool in the first set of monitoring tools receives first mapping information that maps packet information to a first application name and second mapping information that maps the packet information to a second application name, wherein the monitoring tool determines that the first and second application names correspond to the same application and in response thereto generates a common application name.

In some embodiments, the techniques described herein relate to a non-transitory machine-readable medium storing a program executable by at least one processing unit of a device. The program comprising sets of instructions for receiving a policy to filter traffic from a production network, wherein the policy specifies the traffic to be filtered in terms of an application name of an application that generates the traffic to be filtered; receiving data packets from the production network; identifying packet header information in headers of the received data packets generated by the application based on the application name; forwarding a mapping between the application name and the packet header information to a first set of monitoring tools, wherein when the first set of monitoring tools receive queries from a user that specifies traffic using the application name, the first set of monitoring tools use the mapping to access data packets based on the packet header information associated with the application name; and processing the received data packets, including using the identified packet header information to identify data packets generated by the application in the production network from among the received data packets and forwarding the identified data packets to a second set of monitoring tools based on the policy.

In some embodiments, the techniques described herein relate to a non-transitory machine-readable medium, wherein the identified data packets are forwarded to the second set of monitoring tools when the policy includes an action to allow data packets associated with the application identified by the application name set forth in the policy.

In some embodiments, the techniques described herein relate to a non-transitory machine-readable medium, wherein the identified data packets are dropped and not forwarded to the second set of monitoring tools when the policy includes an action to drop data packets associated with the application identified by the application name set forth in the policy.

In some embodiments, the techniques described herein relate to a non-transitory machine-readable medium, wherein the program further comprises a set of instructions for using an application signature database to identify the packet header information in the headers of data packets generated by the application based on the application name.

In some embodiments, the techniques described herein relate to a non-transitory machine-readable medium, wherein the policy is user-provided input that specifies the traffic to be filtered in terms of the application.

In some embodiments, the techniques described herein relate to a non-transitory machine-readable medium, wherein the program further comprises a set of instructions for matching the identified packet header information with headers in the received data packets to identify data packets generated by the application in the production network from among the received data packets.

In some embodiments, the techniques described herein relate to a non-transitory machine-readable medium, wherein one of the monitoring tools receives first mapping information that maps packet header information to a first application name and second mapping information that maps the packet header information to a second application name, wherein the one of the monitoring tools determines that the first and second application names correspond to the same application and in response thereto generates a common application name.

In some embodiments, the techniques described herein relate to a system comprising a set of processing units and a non-transitory machine-readable medium storing instructions that when executed by at least one processing unit in the set of processing units cause the at least one processing unit to receive a policy to process traffic from a production network, wherein the policy specifies to identify application names of applications that generate the traffic; provision an application identification service configure to identify application names of applications; receive data packets from the production network; send the data packets to the application identification service for the application identification service to identify packet header information in headers of data packets generated by a set of applications based on a set of application names; forward a set of mappings between the set of application names and the packet header information to a set of monitoring tools, wherein when the set of monitoring tools receive queries from a user that specifies traffic using one or more application names, the set of monitoring tools use the mapping to access data packets based on the packet header information associated with the one or more application names.

In some embodiments, the techniques described herein relate to a system, wherein the set of monitoring tools is a first set of monitoring tools, wherein the instructions further cause the at least one processing unit to process the received data packets by using the identified packet header information to identify data packets generated by the application in the production network from among the received data packets and forwarding the identified data packets to a second set of monitoring tools based on the policy.

In some embodiments, the techniques described herein relate to a system, wherein the data packets identified by the application identification service are forwarded to the second set of monitoring tools when the policy includes an action to allow data packets associated with the application identified by the application name set forth in the policy.

In some embodiments, the techniques described herein relate to a system, wherein the data packets identified by the application identification service are dropped and not forwarded to the second set of monitoring tools when the policy includes an action to drop data packets associated with the application identified by the application name set forth in the policy.

In some embodiments, the techniques described herein relate to a system, wherein the application identification service uses an application signature database to identify the packet header information in the headers of data packets generated by the set of applications based on the set of application names.

In some embodiments, the techniques described herein relate to a system, wherein a monitoring tool in the set of monitoring tool receives first mapping information that maps packet header information to a first application name and second mapping information that maps the packet header information to a second application name, wherein the monitoring tool determines that the first and second application names correspond to the same application and in response thereto generates a common application name.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A method for managing network flows and executable by a network packet monitoring system, the method comprising:
receiving a policy to filter traffic from a network, wherein the policy specifies the traffic to be filtered in terms of an application name of an application that generates the traffic to be filtered;
receiving data packets from the network;
identifying packet information in the received data packets generated by the application based on the application name;
forwarding a mapping between the application name and the identified packet information to a first set of monitoring tools, wherein when the first set of monitoring tools receive queries from a user that specifies traffic using the application name, the first set of monitoring tools use the mapping to access data packets based on the packet information associated with the application name; and
processing the received data packets, including:
using the identified packet information to identify data packets generated by the application in the network from among the received data packets; and
forwarding the identified data packets to a second set of monitoring tools based on the policy.

2. The method of claim 1, wherein the identified data packets are forwarded to the second set of monitoring tools when the policy includes an action to allow data packets associated with the application identified by the application name set forth in the policy.

3. The method of claim 1, wherein the identified data packets are dropped and not forwarded to the second set of monitoring tools when the policy includes an action to drop data packets associated with the application identified by the application name set forth in the policy.

4. The method of claim 1 further comprising using an application signature database to identify the packet information in the data packets generated by the application based on the application name.

5. The method of claim 1, wherein the policy is user-provided input that specifies the traffic to be filtered in terms of the application.

6. The method of claim 1 further comprising matching the identified packet information with information in the received data packets to identify data packets generated by the application in the network from among the received data packets.

7. The method of claim 1, wherein a monitoring tool in the first set of monitoring tools receives first mapping information that maps packet information to a first application name and second mapping information that maps the packet information to a second application name, wherein the monitoring tool determines that the first and second application names correspond to the same application and in response thereto generates a common application name.

8. A non-transitory machine-readable medium storing a program executable by at least one processing unit of a device, the program comprising sets of instructions for:
receiving a policy to filter traffic from a production network, wherein the policy specifies the traffic to be filtered in terms of an application name of an application that generates the traffic to be filtered;
receiving data packets from the production network;
identifying packet header information in headers of the received data packets generated by the application based on the application name;
forwarding a mapping between the application name and the packet header information to a first set of monitoring tools, wherein when the first set of monitoring tools receive queries from a user that specifies traffic using the application name, the first set of monitoring tools use the mapping to access data packets based on the packet header information associated with the application name; and
processing the received data packets, including:
using the identified packet header information to identify data packets generated by the application in the production network from among the received data packets; and
forwarding the identified data packets to a second set of monitoring tools based on the policy.

9. The non-transitory machine-readable medium of claim 8, wherein the identified data packets are forwarded to the second set of monitoring tools when the policy includes an action to allow data packets associated with the application identified by the application name set forth in the policy.

10. The non-transitory machine-readable medium of claim 8, wherein the identified data packets are dropped and not forwarded to the second set of monitoring tools when the policy includes an action to drop data packets associated with the application identified by the application name set forth in the policy.

11. The non-transitory machine-readable medium of claim 8, wherein the program further comprises a set of instructions for using an application signature database to identify the packet header information in the headers of data packets generated by the application based on the application name.

12. The non-transitory machine-readable medium of claim 8, wherein the policy is user-provided input that specifies the traffic to be filtered in terms of the application.

13. The non-transitory machine-readable medium of claim 8, wherein the program further comprises a set of instructions for matching the identified packet header information with headers in the received data packets to identify data packets generated by the application in the production network from among the received data packets.

14. The non-transitory machine-readable medium of claim 8, wherein one of the monitoring tools receives first mapping information that maps packet header information to a first application name and second mapping information that maps the packet header information to a second application name, wherein the one of the monitoring tools determines that the first and second application names correspond to the same application and in response thereto generates a common application name.

15. A system comprising:
a set of processing units; and
a non-transitory machine-readable medium storing instructions that when executed by at least one processing unit in the set of processing units cause the at least one processing unit to:
receive a policy to process traffic from a production network, wherein the policy specifies to identify application names of applications that generate the traffic;
provision an application identification service configure to identify application names of applications;
receive data packets from the production network;
send the data packets to the application identification service for the application identification service to identify packet header information in headers of data packets generated by a set of applications based on a set of application names;
forward a set of mappings between the set of application names and the packet header information to a set of monitoring tools, wherein when the set of monitoring tools receive queries from a user that specifies traffic using one or more application names, the set of monitoring tools use the mapping to access data packets based on the packet header information associated with the one or more application names.

16. The system of claim 15, wherein the set of monitoring tools is a first set of monitoring tools, wherein the instructions further cause the at least one processing unit to process the received data packets by using the identified packet header information to identify data packets generated by the application in the production network from among the received data packets and forwarding the identified data packets to a second set of monitoring tools based on the policy.

17. The system of claim 16, wherein the data packets identified by the application identification service are forwarded to the second set of monitoring tools when the policy includes an action to allow data packets associated with the application identified by the application name set forth in the policy.

18. The system of claim 16, wherein the data packets identified by the application identification service are dropped and not forwarded to the second set of monitoring tools when the policy includes an action to drop data packets associated with the application identified by the application name set forth in the policy.

19. The system of claim 15, wherein the application identification service uses an application signature database to identify the packet header information in the headers of data packets generated by the set of applications based on the set of application names.

20. The system of claim 15, wherein a monitoring tool in the set of monitoring tool receives first mapping information that maps packet header information to a first application name and second mapping information that maps the packet header information to a second application name, wherein the monitoring tool determines that the first and second application names correspond to the same application and in response thereto generates a common application name.
